(19) United States
(12) Patent Application Publication
(10) Pub. No.: US 2013/0164728 A1
(43) Pub. Date: Jun. 27, 2013

(54) DISPLAY DEVICE

(71) Applicant: Minet Dannhauser, Fryerning (GB)

(72) Inventor: Minet Dannhauser, Fryerning (GB)

(21) Appl. No.: 13/337,637

(22) Filed: Dec. 27, 2011

(51) Int. Cl. G09B 25/00

(52) U.S. Cl. 434/365

(57) ABSTRACT

A display device 10 comprises a base 11 with a profile 17 and a mask 12 movable relative to the base for close alignment therewith. An opening 39 defined within the mask 12 has a shape corresponding to the shape of the profile 17 so that when brought into close alignment, the profile 17 projects through the opening 39. Any sheets 50,51 of material laid over the profile are trapped between the base 11 and the mask 12 so that the profile 17 appears to be covered by the material. Any portion of the sheet 50, 51 extending beyond the profile 17 is concealed. The profile 17 may define at lease part of a human, character or animal body, and the sheets 50, 51 projecting through the opening 39 appear as clothing. The base 11 and the mask 12 may be hinged for relative pivoting movement of those parts.

### TECHNICAL FIELD

The present invention relates to a display device exhibiting a feature and in particular to a display device that enables the appearance of that feature to be modified.

### BACKGROUND OF THE INVENTION

Most children enjoy playing with dolls, figures and other playthings (hereinafter referred to as toys) and they particularly enjoy dressing those toys in different outfits and costumes. However, most toys of that nature are sold with only one outfit and alternative outfits are not readily available. Furthermore, those toys are available in a very wide range of sizes and shapes so a costume designed for one particular toy is unlikely to fit a different toy. Therefore, children that enjoy dressing their toys in different outfits have a very limited range of outfits in their collection. It is simply unfeasible for very young children to make new costumes for their toys and some older children so inclined lack the skill or resources.

### SUMMARY OF THE INVENTION

The display device of the present invention was developed to provide a toy or plaything, but it is also applicable to a range of circumstances in which one may wish to visualise how something may look were its appearance to be modified. For instance a fashion designer may wonder how a pair of trousers might appear when made from a particular fabric, yet without producing those trousers from that fabric it would be difficult to visualise. Though computers can be very effective in performing simulations of that nature, a three-dimensional model is often preferred, particularly for exhibitions and other demonstrations.

It is therefore an object of the present invention to provide a display device useful for modelling a range of features.

It is a further object of this invention to provide a toy that can be dressed (or have the appearance of being dressed) using a range of materials not specifically shaped or sized to dress the toy.

It is yet a further object of this invention to provide a toy that can utilise materials used to dress other toys.

According to the present invention, there is provided a display device comprising
a base;
a profile provided on the base;
a mask movable relative to the base and which may be brought into close alignment with the base;
an opening defined within the mask and having a shape corresponding to the shape of the profile so that when the base and the mask are brought into close alignment the profile projects through the opening; and
a lip extending at least part way around the periphery of one of the mask and the base and the other of the mask and the base is sized and shaped to locate inside the lip when the mask and base are brought into close alignment,
whereby any sheets of material laid over the profile are trapped between the base and the mask so that the profile projecting through the opening appears to be covered at least in part by the material and any portion of the sheet of material extending beyond the profile is concealed.

Preferably the sheets of material are reasonably flexible so that they may follow the contours of the profile and that way any features of the profile may be visible through the material. Advantageously, the sheets of material may be sufficiently thin to fit within a narrow gap defined by the profile and the periphery of the opening, otherwise close alignment of the base and the mask may be inhibited. The sheets may be formed from a range of suitable materials, including natural fabrics, synthetic fabrics, leathers, suedes and so on, and may preferably be of different colours and textures for greater contrast. The material may also be strips, tapes, cords, nets or any other suitable item.

In a preferred arrangement, the base and the mask each has an abutment face that cooperates with the other abutment face when said base is brought into close alignment with the mask. Those abutment faces may have two purposes: the first being to limit movement relative movement of the base and the mask such that the profile cannot project too far through the opening; and secondly, to trap sheets of material therebetween. Alternatively, or additionally, the sheets of material may be trapped between the profile and the periphery of the opening as those features are also part of the base and mask, respectively.

The profile could be that of absolutely anything that one may wish to dress, decorate or otherwise cover in a different material for immediate viewing. For instance, the display device may resemble a small scale view of a room or window arrangement for use by interior designers and the profile for example may be that of a drawn back curtain. Preferably the profile resembles that of a human or animal body or at least part thereof and the sheets of material laid over the profile are visible through the opening and appear as clothing. Most preferably the profile is that of a human or anthropomorphised creature and comprises a torso, two arms and two legs and the opening is correspondingly shaped.

Some features may also be provided on the mask to complement the profile projecting through the opening, particularly those features that are not to be covered by the sheets of the material. For instance, when the profile resembles the torso, arms and legs of a human body, advantageously the head, neck, arms and legs of the human body may be provided on the mask adjacent appropriate parts of the opening. Were the profile to define an entire body, great care would be required when applying the sheets of material to the profile to avoid covering the feet, hands and head, for example.

In a preferred arrangement the profile is integrally moulded to the base thus requiring a single manufacturing process. However, in an alternative embodiment the profile and the base are formed separately, possibly from different materials and subsequently joined by adhesive or fasteners. Most preferably the profile and or the base are formed from a plastics material, which is easily moulded or otherwise formed to include all intricate features.

Preferably, the mask and the base are connected by a hinge thus enabling said mask and said base to pivot in and out of close alignment. This is particularly advantageous because as the base and the mask are brought into close alignment the profile will automatically align with the opening. In the absence of a hinge mechanism maintaining the relative positions of those parts, when the mask and the base are brought into close alignment with one another, care and attention must be given to ensure that the materials remain in their intended position and the opening aligns with the profile.

Locking means may be provided to fix the relative positions of the base and the mask once brought into close alignment. This way, the mask and the base are unlikely to separate inadvertently which would inevitably cause the trapped sheets of material to be displaced. The locking means may include a catch provided on one of the mask and the base and operable selectively to engage the other of said mask and said base. Alternatively, the locking means may comprise a detent provided on the mask or the base and which automatically retains the mask and the base in position. Separation of the mask and the base may be achieved by forcing those items apart, against the bias of the or each detent, thus causing the detent, mask and or base to deform elastically.

In a preferred arrangement the mask is substantially flat and the opening is defined through opposed front and rear faces thereof. Similarly, the base is also substantially flat with front and rear faces and the profile upstands from the forward face. In a preferred arrangement, the rear face of the mask defines its abutment face and the front face of the base surrounding the profile defines its abutment face.

Advantageously strengthening means may be provided on the base or the mask to provide increased rigidity, which may comprise ribs integrally moulded or otherwise formed thereon. This way, the base and mask can be made very thin while still being sufficiently rigid, thus reducing material and therefore cost. The lip adds strength and rigidity to the part on which it is provided and also serves to enclose all material within the display device so that said material is visible only through the opening.

Advantageously, the mask may be adapted selectively to receive further components such as fashion accessories, wigs and so on. These may be attached to the front face of the mask by any suitable means such as holes and cooperating pins provided on the mask and other components, or hook and loop fasteners.

So that the display device may stand up, it may also be provided with support means which may include a pivotable support arm, feet or even a hook or opening by which it may be hung.

Furthermore, a plurality of profiles may be provided on the base and a corresponding number of openings may be provided on the mask, each profile being arranged to project through its respective opening when the base and the mask are brought into close alignment. For example, the plurality of profiles and openings could define a plurality of people adopting different stances, or even a scene where different coloured and textured material could be used to vary the appearance of items in that scene.

The invention may also take the form of a display kit comprising a display device as described above and at least one sheet of material sized to locate between the base and the mask. The display kit may also include further components mountable to the mask or indeed the base and which relate to the scene defined by the display device. For example, where the profile and the opening in the display device define a person or part thereof, the further components may comprise fashion accessories such as handbags, umbrellas, jewellery, suitcases and so forth.

### BRIEF DESCRIPTION OF THE DRAWINGS

By way of example only, two embodiments of the present invention will new be described in detail, with reference being made to the accompanying drawings, in which:

FIG. 1 is a perspective view of a display device according to a first embodiment of the invention;

FIG. 2 is front view of the display device shown in FIG. 1;

FIG. 3 shows two examples of two pieces of material to be fitted to the display device of FIGS. 1 and 2;

FIG. 4 shows a perspective view of the display device shown in FIG. 1, but with the two sheets of material appropriately located thereon;

FIG. 5 shows a front view of the display device shown in FIGS. 1 to 4, but with the materials appropriately positioned;

FIGS. 6A to 6E show front and rear views of three different components to be fitted to the display device;

FIG. 7 shows a front view of the display device shown in FIGS. 5 with the components of FIG. 6;

FIG. 8 is a perspective view of a mask forming part of a display device according to a second embodiment of the invention;

FIG. 9 is a perspective view of a base which cooperates with the mask of FIG. 9 to form a display device; and

FIG. 10 is a rear perspective view of a display device according to the second embodiment of the invention.

### DETAILED DESCRIPTION OF THE INVENTION

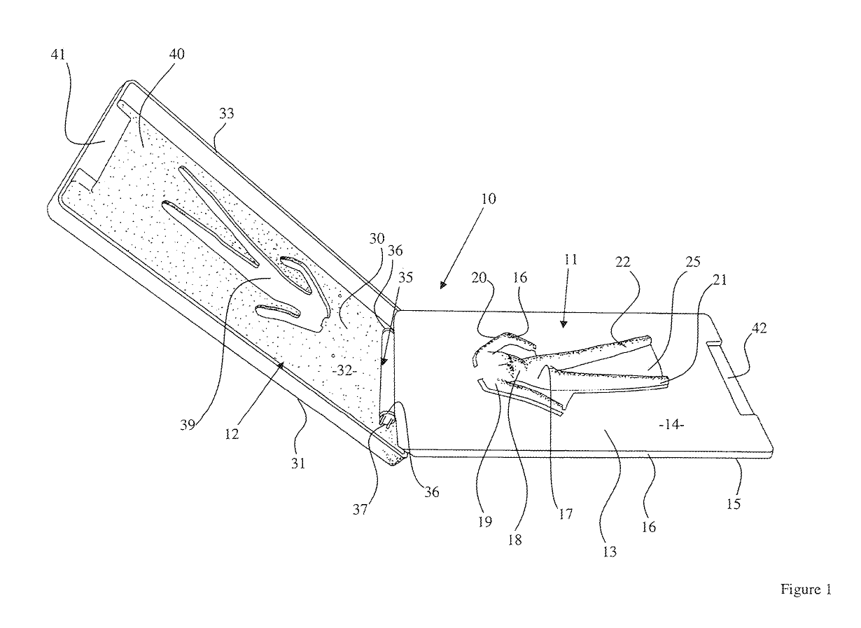

Referring initially to FIG. 1, there is shown a display device in the form of a toy generally indicated 10, and which includes a base 11 and a mask 12. The base 11 comprises a substantially flat rectangular panel 13 having opposed front and rear faces 14,15 and a peripheral surface 16. A female body portion 17 comprising a torso 18, arms 19,20 and legs 21,22 is mounted to the front face 14 of the panel 13 so as to project forward thereof and define the profile. In this particular embodiment a cut-out 25 is formed through the panel 13 and the body portion 17 is disposed over that with the ends of the arms 19,20 and legs 21,22 of the body portion 17 being bonded to the base 11. One purpose of the cut-out 25 is to reduce the amount of material used and a second purpose will be discussed further below.

The mask 12 comprises a flat member 30 having opposed front and rear surfaces 31,32 and a rim 33 extending around the periphery of the rear face 32. The mask 12 is coupled to the base 11 by a simple hinge mechanism 35 which permits relative pivoting movement of those parts. The simple hinge mechanism 35 comprises a pair of flanges 36 upstanding from the rear face 32 of the mask and each having an aperture (not shown) for receiving one of a pair of lugs 37 provided on the end of the base 11. An opening 39 is formed through the middle of the flat member 30 and has a shape corresponding to that of the female body portion 17 provided on the base 11, but is slightly larger. Provided at the lower end 40 of the mask 12 is an abutment 41 sized to form a snug fit within a recess 42 defined on the front face 14 of base 11.

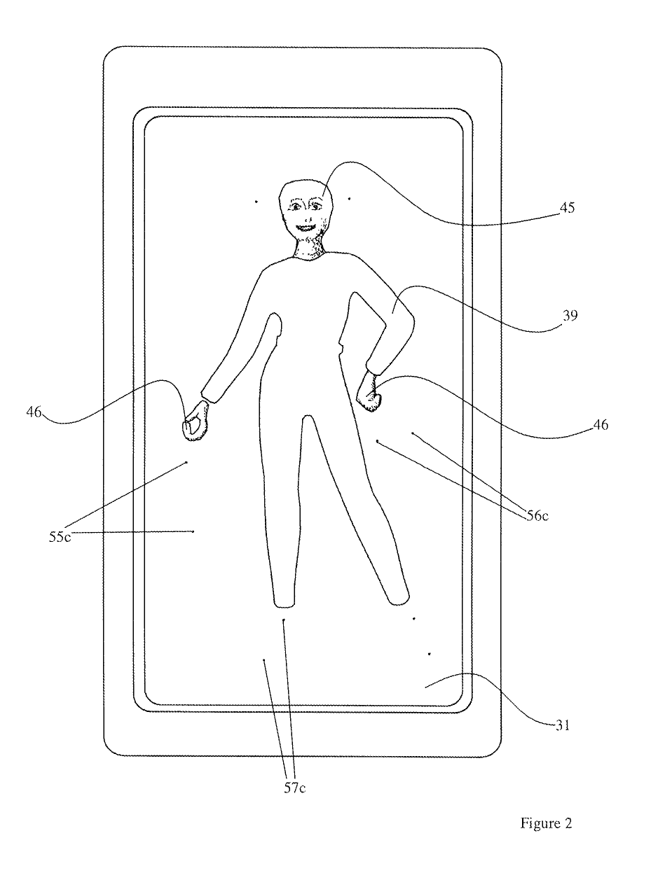

Referring to FIG. 2, the front face 31 of the mask 12 is provided with a head 45 located next to the torso part of the opening 39 and a pair of hands 46 located next to the arm portions of the opening 39.

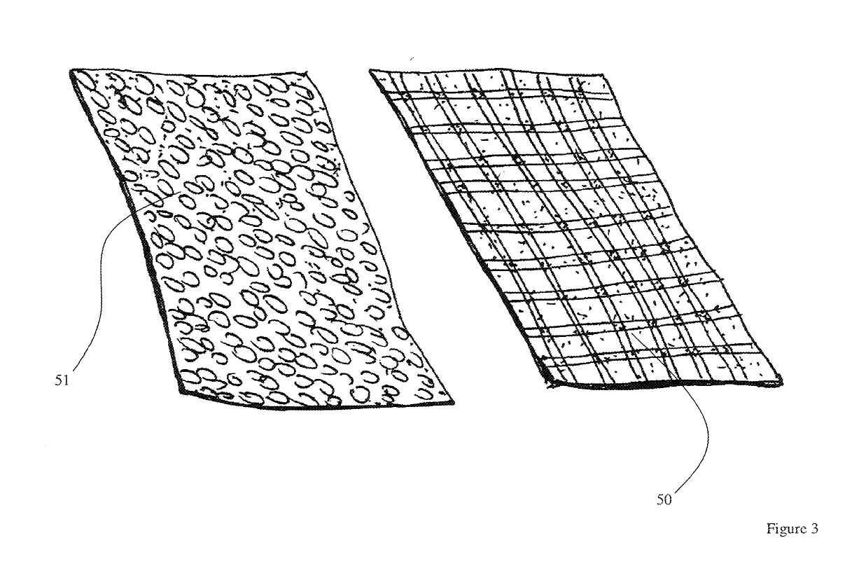

This display device may be used as a toy that may be dressed with different swatches of material or even as a tool in the fashion industry for visualising new fabrics. Some examples of swatches 50,51 of material that may be used with this display device 10 are shown in FIG. 3 and most preferably are no wider than the display device.

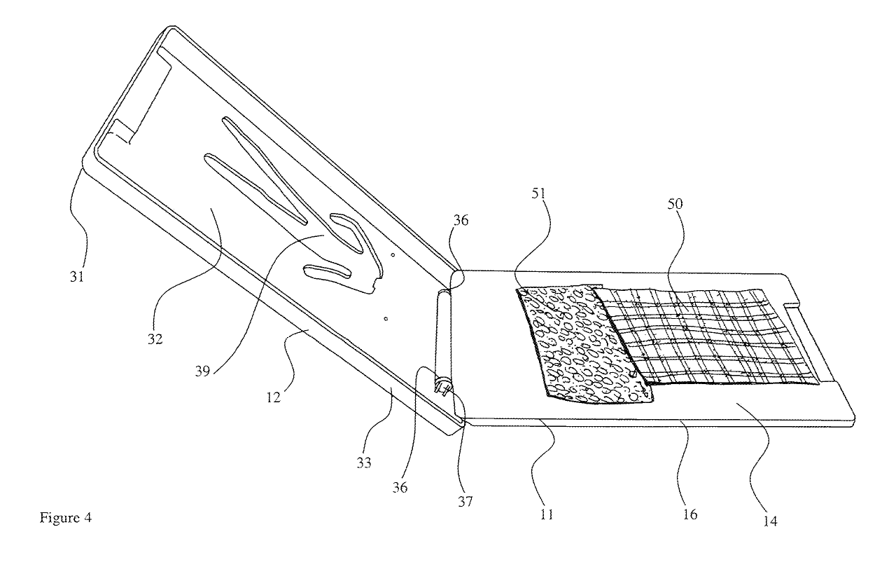

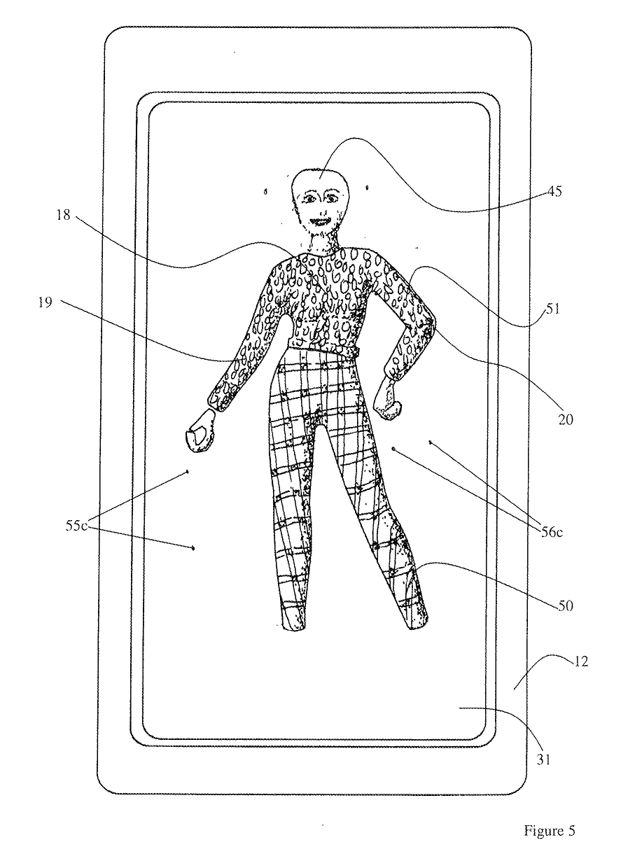

Referring to FIG. 4, the swatches 50,51 are disposed over the body portion 17 in any appropriate position. In this view swatch 50 covers the legs 21,22 and swatch 51 covers the torso 18 and the arms 19,20. The mask 12 is then pivoted until its rear face 32 cooperates with the front face 14 of the base 11 and the rim 33 around the mask 12 encloses the peripheral face 16 of the base 11. At the same time, the body portion 17 and parts of the swatches 50,51 covering the body portion are urged through the opening 39. This causes the swatches 50,51 to tighten around the body portion 17 to give the appearance of clothing, as shown in FIG. 5. Parts of the swatches 50,51 not covering the body portion 17 become trapped between the front face 14 of the base 11 and the rear face 32 of the mask 12, thus remaining secure and concealed. In fact, depending on the relative dimensions of the opening 39 and the body portion 17, the swatches may also be gripped by the periphery of the opening and the corresponding part of the body portion 17.

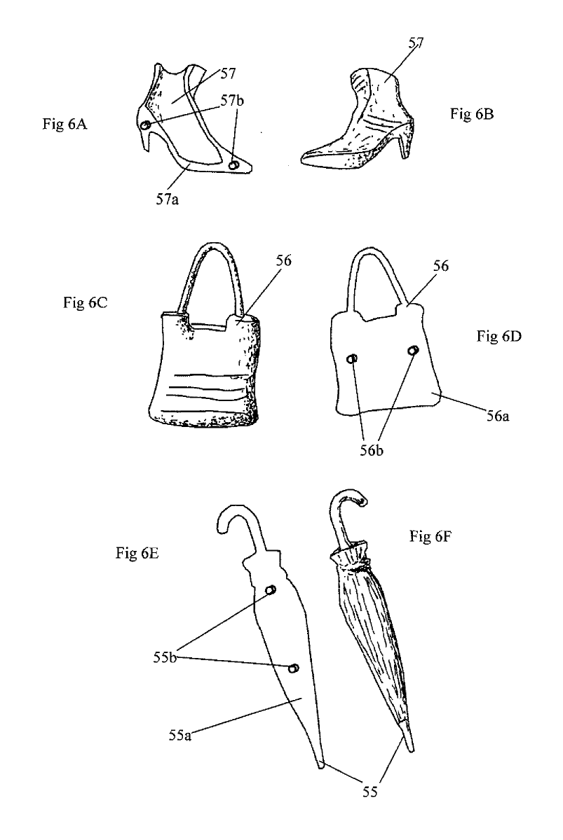

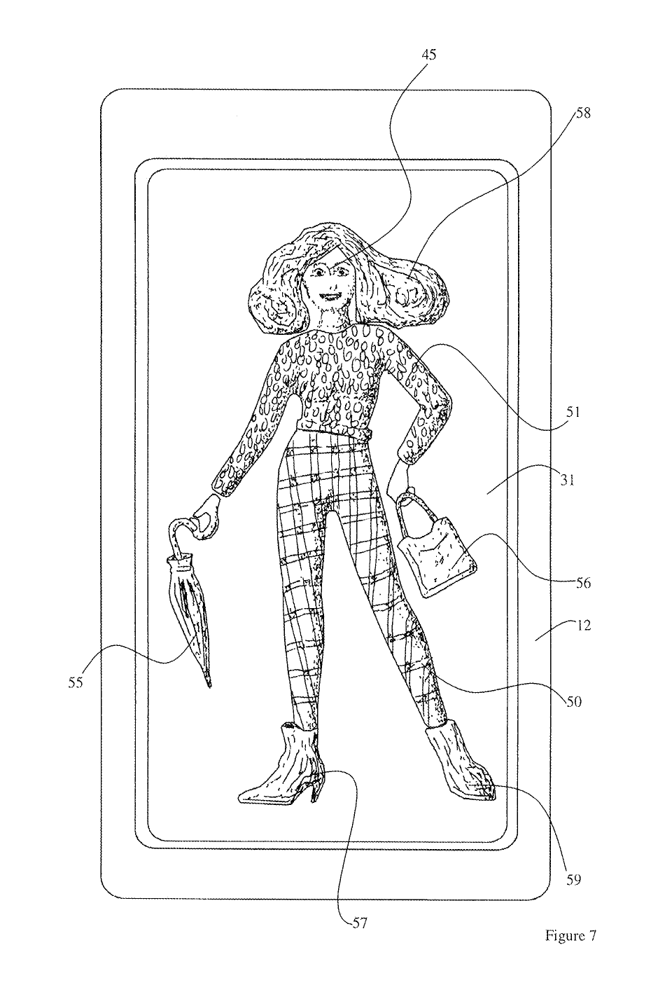

FIGS. 6A to 6E show front and rear views of an umbrella 55, a handbag 56 and a boot 57 that may be attached to the front face 31 of the mask 12 to give the appearance that they are being worn or held. Each item has a flat rear face 55a, 56a, 57a that mounts against the front face 31 of the mask 12 and a pair of pins 55b, 56b, 57b that locate in appropriately positioned holes 55c, 56c, 57c formed in the front face 31. In this particular embodiment the location of the pins 55b on the umbrella 55 is different from the location of the pins 56b on the handbag 56 and therefore the handbag 56 may locate only adjacent the left arm 19 and the umbrella 55 may locate only next to the right arm 20. Of course, in other embodiments all the pins and holes may be spaced a set distance apart and in a set orientation so that any particular item can be located anywhere on the front face 31 of the mask 12. FIG. 7 shows the front face 31 with the umbrella 55, handbag 56 and boot 57 located in position, along with a hair piece 58 and another boot 59. Indeed, the items 55,56,57 shown in FIG. 6 are only a small selection of the many items that may be fitted to the front face 31 of the mask, or even the base provided the opening is adapted accordingly or another opening is provided.

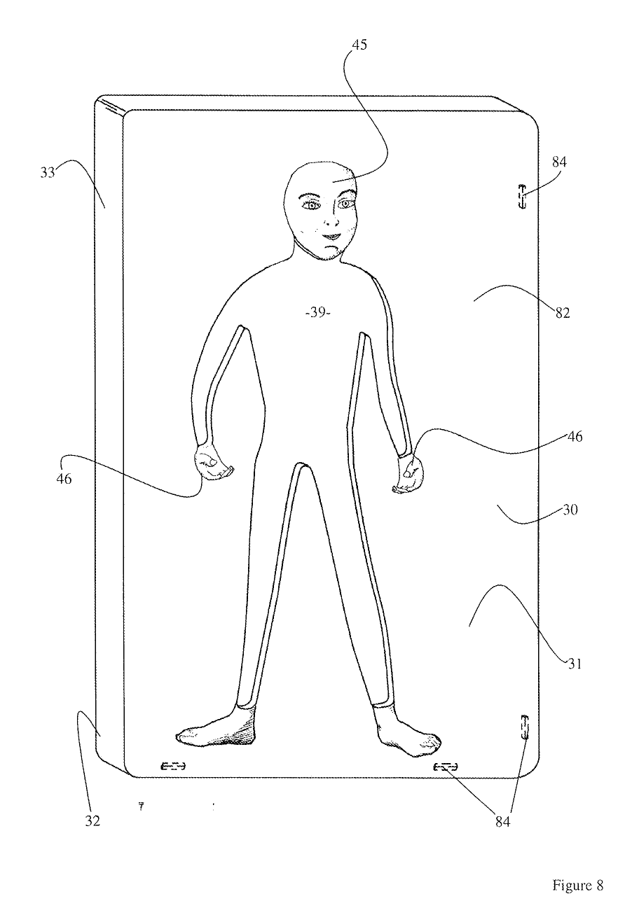

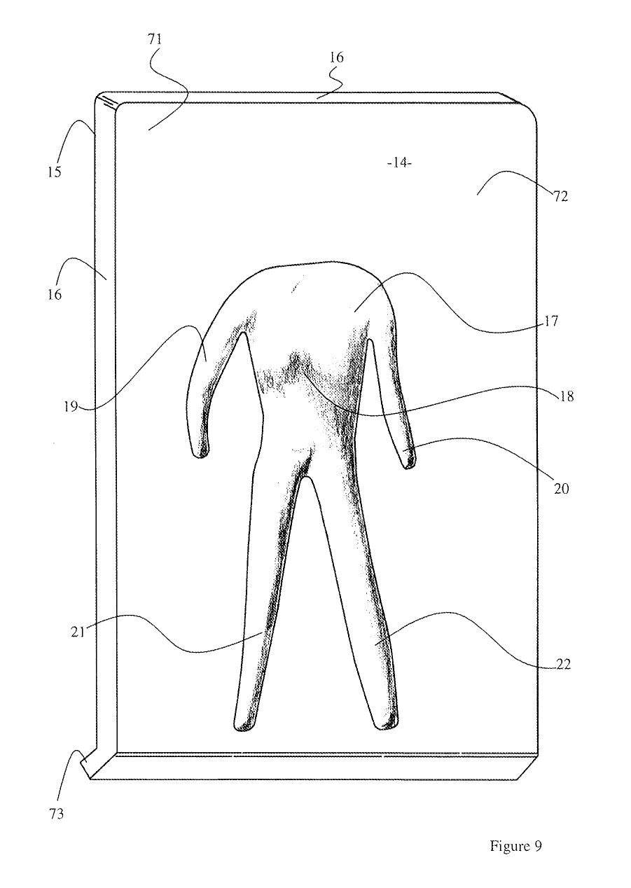

FIGS. 8 to 10 show a second embodiment of the invention which is similar to the first embodiment and therefore like features have been given like reference numerals. In this particular embodiment the base 71 and the mask 82 are not hingedly linked together and are two separable components. The advantage of this is that they may be produced using two simple moulds having no hinge arrangement and the extra step of assembling those two components is also avoided.

The base 71 comprises a rectangular panel 72 having a front face 14 provided with a body portion 17 and a rear face 15 provided with a rearwardly extending flange 73. The mask 82 is very similar to the mask 12 of the previous arrangement insofar as it includes a flat member 30 having opposed front and rear faces 31,32 and also a lip 33 extending around the periphery of the rear face 32. The opening 39 is similar to that of the previous embodiment. A plurality of detents 84 are provided around the internal face 85 of the lip 33 and spaced above the rear face 32 by a distance a little greater than the thickness 16 of the base 71. In use, swatches (not shown) are placed over the body portion 17 as appropriate and the mask 85 is then lowered over the base 71 so that the body portion 17 and parts of the swatches locate in the opening 39. In so doing, the detents 84 and the lip 33 deform temporarily to permit the base 71 to pass thereby so that its front face 14 cooperates with the rear face 32 of the mask 82 causing the swatch to be trapped therebetween, as described in the previous embodiment.

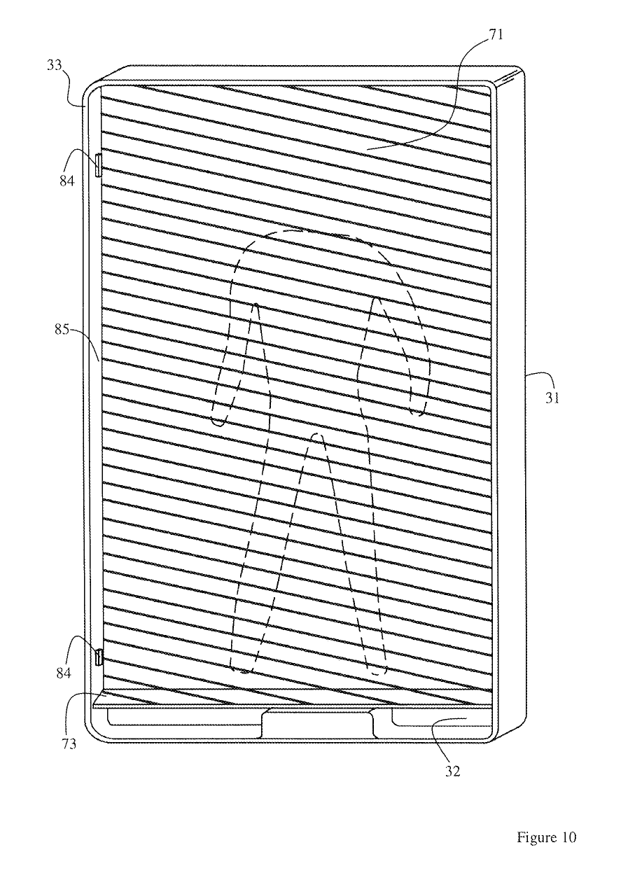

Referring to FIG. 10, to release the base 71 from within the mask 82 one must grasp the upstanding flange 73 and urge the base 70 away from the mask against the bias of the detents 84, which will deform to let the base pass once sufficient force is applied.

1. A display device comprising
a base;
a profile provided on the base;
a mask movable relative to the base and which may be brought into close alignment with the base;
an opening defined within the mask and having a shape corresponding to the shape of the profile so that when the base and the mask are brought into close alignment, the profile projects through the opening; and
a lip extending at least part way around the periphery of one of the mask and the base, and the other of the mask and the base is sized and shaped to locate inside the lip when the mask and base are brought into close alignment,
whereby any sheets of material laid over the profile are trapped between the base and the mask so that the profile projecting through the opening appears to be covered at least in part by the material and any portion of the sheet of material extending beyond the profile is concealed.

2. A display device as claimed in claim 1, wherein the base and the mask each have an abutment face that cooperate with one another when said base is brought into close alignment with the mask.

3. A display device as claimed in claim 1, wherein the profile defines a representation of at least part of a human or animal body.

4. A display device as claimed in claim 3, wherein the profile is that of a human or anthropomorphised creature and comprises a torso, two arms and two legs.

5. A display device as claimed in claim 3, wherein at least part of the body is defined on the mask adjacent the opening.

6. A display device as claimed in claim 1, wherein the profile is integrally molded to the base.

7. A display device as claimed in claim 1, wherein the profile is fastened or bonded to the base.

8. A display device as claimed in claim 1, wherein the mask is coupled to the base by a hinge to permit relative movement between said mask and said base.

9. A display device as claimed in claim 1, wherein locking means are provided to fix the relative positions of the base and the mask once brought into close alignment.

10. A display device as claimed in claim 1, wherein the base and the mask comprise panels.

11. A display device as claimed in claim 1, wherein strengthening means are provided on the base and or mask to provide increased rigidity.

12. A display device as claimed in claim 1, wherein the mask has a front face to which additional features are securable.

13. A display device as claimed in claim 1, further comprising support means adapted to support the display device in a desired position.

14. A display device as claimed in claim 1, wherein a plurality of profiles are provided on the base and a corresponding number of openings are provided on the mask, each profile being arranged to project through its respective opening when the base and the mask are brought into close alignment.

15. A display device as claimed in claim 1, wherein the base and or the mask are made from plastics.

16. A display kit comprising a display device according to claim 1 and at least one sheet of material sized to locate between the base and the mask.

17. A display kit as claimed in claim 16, comprising components mountable to the mask or indeed the base and which relate to the scene defined by the display device.
